(19) United States
(12) Patent Application Publication
(10) Pub. No.: US 2008/0056152 A1
(43) Pub. Date: Mar. 6, 2008

(54) Measurement data communication device, health information communication device, information acquisition device, measurement data communication system, method of controlling measurement data communication device, method of controlling information acquisition device, program for controlling measurement data communication device, and recording medium

(75) Inventors: Hirotsugu Yano, Amagasaki-shi (JP); Hiroaki Niwamoto, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/515,012

(22) Filed: Sep. 5, 2006

(51) Int. Cl. H04L 12/26

(52) U.S. Cl. 370/252

(57) ABSTRACT

A measurement data communication device of the present invention transmits, to an information acquisition device, a measured value which indicates the health condition of a measurement target. In this measurement data communication device, a communication section transmits, to the information acquisition device, communication information including a measurement name corresponding to the measured value and a code value corresponding to the measurement name. Also, a measurement data generation section generates measurement data from the code value and the measured value. The measurement data communication device of the present invention can therefore cause the information acquisition device to recognize the measurement name corresponding to the code value, when measurement data communication device transmits the measurement data to the information acquisition device.

### FIELD OF THE INVENTION

The present invention relates to a measurement data communication device which transmits measurement data to an information acquisition device that recognizes, using codes, an actual measurement name of a measured value, a method of controlling the measurement data

communication device, a program for controlling the measurement data communication program, a recording medium, and the like. In particular, the present invention relates to a health information communication device which outputs measurement data acquired by measuring the health condition (physical information, biological information) of the user, a system for collecting sets of measurement data by a health information collection device (home gateway) in a home.

### BACKGROUND OF THE INVENTION

High-speed communication systems conventionally use XML (Extensible Markup Language) or other standards for data communication, and can transmit data with required measurement conditions. The data has attributes or the like which are clearly set. On this account, it is unnecessary to carry out data analysis in the system and data conversion in line with the standards, i.e. the data is valid in itself. Also, since the data can be analyzed by a third party, the reuse of the data is feasible.

In low-speed communications, on the other hand, data with the same content requires a large amount of time for the transmission. On this account, conventional low-speed communication systems transmit bare essentials of the data, by performing, for example, code conversion of the items of the data. The data is then converted by a receiving-end device, based on a predetermined standard, for example. In this manner, commonly-utilizable data which is actually required is generated.

Patent Document 1 (Japanese Laid-Open Patent Application No. 8-6828; published on Jan. 12, 1996) discloses a data processing method. Patent Document 2 (Japanese Laid-Open Patent Application No. 9-503326; published on Mar. 31, 1997) discloses a method of storing and fetching data and a device for the same Patent Document 3 (Japanese Laid-Open Patent Application No. 2001-103079; published on Apr. 13, 2001) discloses a data transmitter/receiver and a data transmitting/receiving method. Patent Document 4 (Japanese Laid-Open Patent Application No. 2003-333107; published on Nov. 21, 2003) discloses an authentication method of a network-connectable device. Patent Document 5 (Japanese Examined Patent Publication No. 6-81142; published on Oct. 12, 1994) discloses how an integrated device having plural functions is controlled. Patent Document 6 (Japanese Laid-Open Patent Application No. 2000-59404; published on Feb. 25, 2000) discloses a home network system which centrally controls terminals. Patent Document 7 (Japanese Laid-Open Patent Application No. 2002-189852; published on Jul. 5, 2002) discloses a home server system.

However, as described above, in conventional low-speed communication systems, a communication device can be connected to a communication medium (network) only when a receiving-end device has means for converting the data supplied from the communication device.

In devices in conformity to the ECHONET standard (Non-Patent Document 1; ECHONET SPECIFICATION APPENDIX Detailed Stipulations for ECHONET Device Objects, Ver 2.11 Release a; published on Apr. 26, 2002 by Echonet Consortium) in which a communication format is a general-purpose type, different types of devices have different definitions of data items. On this account, after an item is newly added, data conversion is no longer possible by the system before the addition. Moreover, in case where a device-specific function is added, this function is unique to the manufacturer of that device. The function cannot be shared in this case, for example. To solve this problem, conversion data may be acquired from the manufacturer via the Internet. This solution, however, cannot be applied to communication systems which are made up only of basic devices (communication devices) and are not connected to an external communication infrastructure such as the Internet, i.e. standalone systems.

Moreover, since it is premised that data conversion is carried out in a receiving-end device, data exchange between devices connected to a single communication medium cannot be done if the system does not include a device which can carry out data conversion (e.g. a device having a corresponding equipment object, in the case of the ECHONET).

As to data for health information communication devices and health information collection devices, the vital data communication defined in Non-Patent Document 2 (Vital Data Communication Specification (V1.0 JAHIS)—between in-home control device and a vital sensor/adopter—; Japanese Association of Healthcare Information System Industry, Community Healthcare System Committee; published in January, 2001) puts limitations on devices to bc used, even in a high-speed communication environment. Moreover, the vital data communication is arranged in such a manner that one individual item (measurement item) is placed in a code value which is determined and fixed in advance. On this account, the vital data communication is too restrictive to be used generally for health information communication devices.

In conventional health information communication devices which use a low-speed communication medium, the increase in communication time is prevented by increasing the communication efficiency by means of reduction of a data size to be transmitted. This reduction of the data size is actually carried out as follows. That is, in case where an actual measurement name is transmitted without any conversion, the data length corresponding to the characters of the measurement name is required, and communication time corresponding to the data length is required. To solve this problem, a measurement name based on a standard or the like is converted to an optional unique code, and the transmission of the measurement name is carried out using the code value. If data communication with a reduced data size is carried out while no standard or the like is used, the length of a code value is limited, and the variations of allocated measurement names are also limited. In this case, however, similar measurement names may have the same code value. Moreover, since each manufacturer can arbitrarily allocate codes, it is impossible to specify measurement names, in a communication system in which various types of health information communication devices (equipments) are included.

A code value may be uniquely allocated to a measurement name. In this case, however, the number of code values to be used in the health information is innumerous, unless the code values are determined with the limited number of measurement names used in a health information communication device. That is to say, without limiting the number of measurement names, the data length of the code values is long and hence the reduction of the data size cannot be achieved. On the other hand, when the number of measurement names is limited, it is difficult to newly add items.

Moreover, measurement data supplied to a health information collection device (receiving-end device) is insufficient for analysis, because measurement names are unknown. For this reason, a conventional data analysis by a health information collection device is carried out in such a manner that a code value is written in advance into an application for the analysis in the health information collection device. Such writing of a code value, however, is possible only when a health information communication device connected to a network (i.e. constituting a communication system) is known. In case where the configuration of the communication system is changed, the health information collection device is upgraded by obtaining required information via an external network. Such a communication system, however, cannot obtain information regarding communication, when the system is standalone, i.e. not connected to a network through which an application is obtained. Furthermore, in case where a measurement device (i.e. health information communication device itself or a function of a health information communication device) having a new function is introduced, a corresponding application cannot be provided by a provider of the device, until information disclosure regarding the device, establishment of a standard regarding the device or the like is officially done.

A conventional health information collection device using a low-speed communication medium collects data with improved communication efficiency. This improvement in the communication efficiency is achieved by reducing a data size for communication, because a data size influences on communication time. In practice, a standard limits the number of shared measurement items for data communication, and either measurement names are allocated to a limited number of code values or the standard determines which measurement names and code values are used in each type of measurement device. The limitation of the number of code values is solved in this manner. In any case, the combinations of measurement names and code values are determined in consideration of values corresponding to a standard and devices constituting the system in advance, i.e. at the time of making the software of the health information collection device. On this account, analysis of supplied data and data conversion of the supplied data cannot be carried out, in case where a value not supported by the standard, a health information communication device having a function not supported by the standard, or the like, is added to the system. This can be solved by upgrading the control software of the health information collection device by means of an external communication medium. In this case, however, system management even in consideration of terminals is required. The upgrade of information cannot be done if the system is standalone.

### SUMMARY OF THE INVENTION

The present invention was done to solve the above-identified problem. The objective of the present invention is to provide a measurement data communication device or the like, which can cause, under any circumstances, an information acquisition device to recognize a measurement name, when measurement data is supplied.

To achieve this objective, the measurement data communication device (health information communication device) of the present invention, which transmits, to an information acquisition device, a measured value indicating a health condition of a measurement target, includes: communication information transmitting means (communication section) for transmitting, to the information acquisition device, communication information which is constituted by a measurement name corresponding to the measured value and a code value corresponding to the measurement name; and measurement data generating means (measurement data generation section) for generating measurement data, based on the code value and the measured value.

According to this arrangement, a measurement name of a measured value indicating a health condition of a measurement target and communication information indicating how the measurement name correlates with a code value are transmitted, so that a measurement name corresponding to a code value which is supplied later can be notified in advance. On this account, in case where a measured value with a new measurement name is transmitted, it is possible to transmit the code value corresponding to the new name. That is, it is possible to notify the information acquisition device of correspondence between code values and measurement names. Therefore, under any circumstances, it is possible to cause the information acquisition device to recognize a measurement name corresponding to a code value, by transmitting, to the information acquisition device, measurement data including the code value and the measured value. In case where a measurement name is represented by a character string, the character string may include not only characters but also numbers.

Also, because communication information indicating correspondence between a measurement name and a code value is transmitted, measurement data can be transmitted without increase in the data size. Therefore, in case of low-speed communication, data communication is feasible without increasing the size of the transmitted data. In case of high-speed communication, the speed of data communication is improved. This makes it possible to create a communication environment which is efficient and user-friendly.

To achieve the objective above, the information acquisition device (health information collection device) of the present invention includes: first communication means (communication section) for receiving, via a network, measurement data which includes at least a measured value indicating a health condition of a measurement target; and measurement data converting means (data conversion section) for recognizing a measurement name corresponding to the measured value in the supplied measurement data and converting the measurement data based on a particular format, in case where the measurement data includes a code value corresponding to the measurement name and there has been supplied communication information which indicates a relationship between the measurement name and the code value, the measurement data converting means recognizing the measurement name by the communication information and the code value in the measurement data, whereas in case where the measurement data includes data indicating the measurement name, the measurement data converting means recognizing the measurement name by the data indicating the measurement name.

According to this arrangement, in case where measurement data includes a code value and there has been supplied communication information indicating correspondence between the code value and a measurement name, it is possible to recognize the measurement name corresponding to the measured value included in the measurement data, based on the code value in the measurement data. On this account, even if sets of measurement data in which different code values correspond to the same measurement name, these sets of measurement data can be converted based on the same format.

In case where measurement data includes data indicating a measurement name, the measurement name is recognized based on this data, and the measurement data is converted based on a particular format.

Therefore, the aforesaid information acquisition device can standardize the measurement data, under any circumstances.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram showing a health information communication device of an embodiment.

FIG. 2 is a block diagram of a biological information collection system of the embodiment.

FIG. 3 is a flowchart showing how the health information communication device of the embodiment operates.

FIG. 4 is a block diagram showing a health information collection device of the embodiment.

FIG. 5 is a flowchart showing how the health information collection device of the embodiment operates.

FIG. 6 shows an example of a communication code identifier.

FIG. 7 shows an example of a code identifier.

FIG. 8 shows an example of a data length identifier.

FIG. 9 shows an example of a data format of a communication information unit.

FIG. 10 shows an example of a data identifier by which the type of data is identified.

FIG. 11 shows an example of a data format of a communication information unit with an accompanied condition.

FIG. 12(a) shows an example of a data format of a measurement data unit.

FIG. 12(b) shows another example of the data format of the measurement data unit.

FIG. 12(c) shows a further example of the data format of the measurement data unit.

FIG. 13 shows an example of a data format of a measurement data unit with an accompanied condition.

FIG. 14 shows an example of a measurement data identifier for identifying a measurement data unit.

FIG. 15 shows an example of a measurement data identifier for identifying a measurement data unit with an accompanied condition.

FIG. 16 shows an example of a data format of measurement group data.

FIG. 17 shows a measurement data identifying for identifying measurement group data.

### DESCRIPTION OF THE EMBODIMENTS

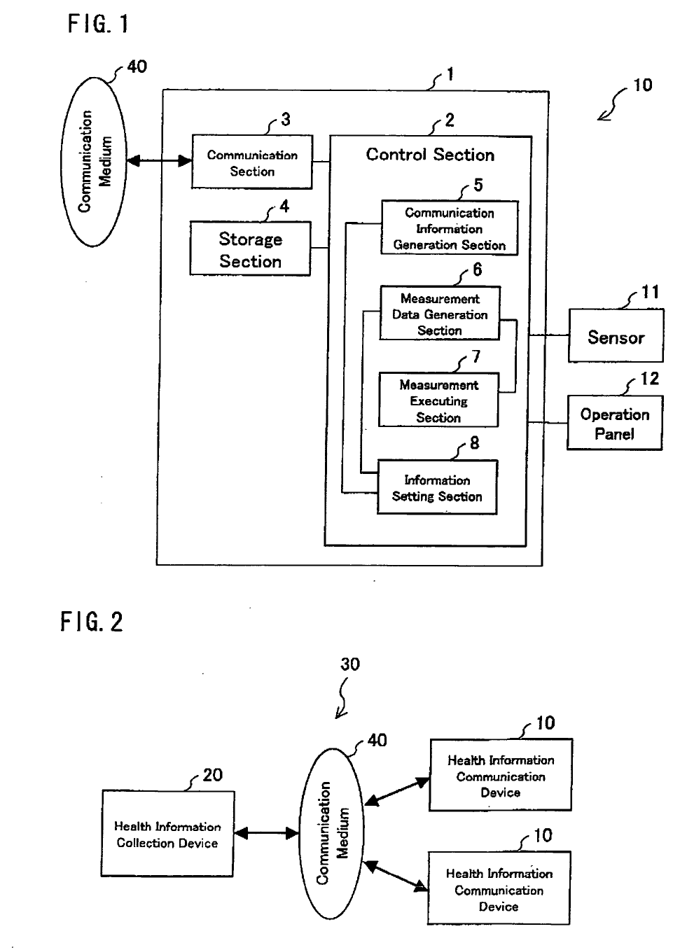

The following will describe an embodiment of the present invention in reference to FIGS. 1-17. Although the present embodiment deals with a measurement data communication device as a part of a health information communication device, the present invention is not limited to this case. Also, although an information acquisition device in the present embodiment is used as a health information collection device, the present invention is not limited to this case.

FIG. 2 shows a biological information collection system (measurement data communication system) 30 of the present embodiment. As shown in this figure, the biological information collection system 30 of the present embodiment is constituted by health information communication devices 10 and a health information collection device (information acquisition device) 20. In the biological information collection system 30, data such as health information of a measurement target is exchanged between the health information communication devices 10 and the health information collection device 20, via a low-speed communication medium (network) 40. The system 30 can also adopt a high-speed communication medium, without any problems. Such a high-speed communication medium decreases time required for communications.

The biological information collection system 30 is arranged such that, in reference to an identifier such as a physical address for communication, the health information collection device 20 can identify from which health information communication device 10 data is supplied, as to all types of data supplied from the health information communication devices 10.

(Health Information Communication Device)

The health information communication device 10 of the present embodiment will be discussed in reference to FIG. 1. As shown in this figure, the health information communication device 10 includes a measurement data communication device 1, a sensor 11, and an operation panel 12.

The measurement data communication device 1 includes a control section 2, a communication section (communication information transmitting means) 3, and a storage section 4.

The control section 2 centrally controls the operations of various sections in the health information communication device 10. The control section 2 includes: a communication information generation section 5 that generates communication information; a measurement data generation section (measurement data generating means) 6 that generates measurement data; a measurement executing section 7 that acquires, from the sensor 11, a measured value and data of accompanied conditions regarding the measured value; and an information setting section 8 that acquires setting information which its inputted by the user using the operation panel 12. Details of the communication information and the measurement data will be given later.

The control section 2 is, for example, constituted by a CPU of a low-speed embedded unit. Alternatively, the control section 2 may be a personal computer. The operations of the components are controlled by causing a computer to execute a control program. For example, the program may be stored in a ROM (Read Only Memory), loaded from a removable medium such as a CD-ROM and executed, or loaded from a hard disc and executed. In case where the control section 2 is connected to a communication network such as the Internet, the program may be downloaded through the communication network, installed in a hard disc or the like, and executed.

The communication section 3 exchanges data with a health information collection device placed inside/outside a home, via a low-speed communication medium 40.

The storage section 4 is constituted by either a RAM (Random Access Memory) with a backup power source or a non-volatile storage device such as a flash memory and hard disc. Stored in this storage section 4 are, for example: the aforesaid control program; other types of programs; data indicating in what manner a binary value (code value) relates to a measurement name, which data is set for each health information communication device; measurement data; processing data; or the like.

The sensor 11 measures health information (physical information, biological information) of a measurement target. Non-restrictive examples of the health information include weight, body fat, blood pressure, and body temperature. The number of the sensor 1 may be one or more than one.

The operation panel 12 receives inputs from the user, in regard of information of the measurement target and conditions of the measurement. In other words, the user can set, using the operation panel 12, setting information of information regarding the measurement target and conditions of the measurement.

The health information communication device 10 outputs, to the outside, information such as measurement data, setting information, and communication information. This data communication by the health information communication device 10 is carried out using the communication section 3 and via the communication medium 40. The health information communication device 10 receives, from another communication device and via the communication medium 40, request information which requests communication information. In doing so, the health information communication device 10 uses the communication section 3. Also, using the communication section 3, the health information communication device 10 transmits the communication information to the communication device that has requested the information, via the communication medium 40.

(Operation of Health Information Communication Device)

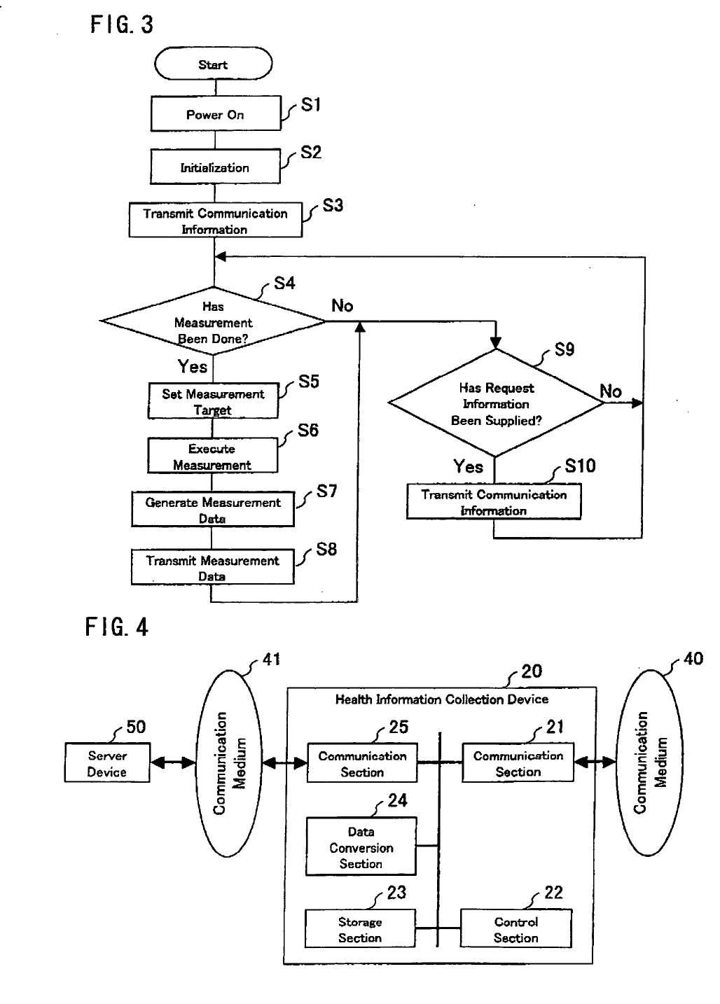

The following will describe how the health information communication device 10 operates, in reference to the flowchart in FIG. 3.

The health information communication device 10 is powered in Step 1 (hereinafter, “Step” will be referred to as “S”), and is initialized in S2. The health information communication device 10 transmits communication information in S3. In S3, the communication information generation section 5 fetches data from the storage section 4 which stores data indicating in what manner a binary value relates to a measurement name, which data is set for each health information communication device. Also in S3, the communication information generation section 5 transmits, using the communication section 3, the communication information to a receiving end, via the external communication medium 40.

In S4, the health information communication device 10 determines whether or not health information is measured. If a measurement is carried out (YES in S4), the process proceeds to S5. If a measurement is not carried out (NO in S4), the process proceeds to S9.

In S5, the user sets, using the operation panel, setting information of information of a measurement target and conditions of a measurement. The process then proceeds to S6.

In S6, the sensor 11 measures the health information of the measurement target.

In S7, the measurement data generation section 6 generates measurement data, using the measured value acquired in S6 and a code value supplied in S3. The process then proceeds to S8.

In S8, the communication section 3 outputs the measurement data, and the process proceeds to S9.

In S9, it is determined whether or not request information by which communication information is requested has been supplied from another device. If there has been no request information (No in S9), the process goes back to S4. If request information has been supplied (YES in S9), communication information is outputted in S10, and the process goes back to S4. Since whether or not request information has been supplied is checked as above, information transmission is feasible even if the system configuration and/or the state of the system is changed. This allows (i) a health information collection device which does not have information of the health information communication device, because of alteration of a transmitting-end device and (ii) another health information communication device to acquire the communication information.

(Health Information Collection Device)

The following will describe the health information collection device 20 of the present embodiment, in reference to FIG. 4. As shown in FIG. 4, the health information collection device 20 includes a communication section (first communication means) 21, a storage section 22, a control section 23, a data conversion section 24, and a communication section (second communication means) 25.

The communication section 21 carries out data communication with at least one health information communication device 10, via a low-speed communication medium 40. In case where communication information is not supplied from a health information communication device 10, the communication section 21 transmits, to the health information communication device 10, request information by which the device 10 is requested to transmit communication information.

The control section 23 centrally controls the operations of the components of the health information collection device 20. The control section 23 is constituted by, for example, a CPU of a low-speed embedded unit. Alternatively, the control section 23 may be a personal computer. The operations of the components are controlled by causing a computer to execute a control program. For example, the program may be stored in a ROM (Read Only Memory), loaded from a removable medium such as a CD-ROM and executed, or loaded from a hard disc and executed. In case where the control section 23 is connected to a communication network such as the Internet, the program may be downloaded through the communication network, installed in a hard disc or the like, and executed.

The storage section 23 is constituted by either a RAM (Random Access Memory) with a backup power source or a non-volatile storage device such as a flash memory and hard disc Stored in this storage section 23 are, for example: the aforesaid control program; other types of programs; communication information supplied from a health information communication device 10; measurement data; or the like.

The data conversion section (measurement data converting means) 24 extracts measurement data from the storage section 23, and subjects the extracted data to data conversion for each item such as, for example, data of each measurement target which is required by a database of a healthcare service or a provider of a healthcare service.

The communication section 25 transmits, either individually or in a lot, sets of measurement data which have been subjected to the data conversion by the data conversion section 24, to server device 50, via a high-speed communication medium 41. The server device 50 is, for example, a server of a company (so-called ASP: Application Service Provider) which provides a healthcare service on the net. The server device 50 performs the following process, for example.

The server device 50 classifies data, which are supplied from health information communication devices 10 to the health information collection device 20, into sets of data of the respective health information communication devices 10. In doing so, the server device 50 centrally manages the sets of data of the respective health information communication devices 10, in an internal database. The server device 50 may classify those sets of data into measurement items or measurement targets, and centrally manage the sets of data in units of measurement items, measurement targets, or the like, in the internal database.

Also, the server device 50 displays data supplied from the health information communication device 10 or generates data for display. The data display or data generation may be carried out in units of health information communication devices 10, measurement items, measurement targets, or the like, which are managed by the internal database.

In response to a request from a healthcare service provider, the health information communication device 10, or the health information collection device 20, the server device 50 extracts, from the internal database, requested data such as health data of a measurement target, and transmits the extracted data back to the requestor.

In case where the health information communication device 10 can receive data from another health information communication device, that health information communication device 10 can function as a health information collection device. This health information collection device does not have a communication section 25 which is connected to the communication medium 41 on the healthcare-service side.

The health information collection device 20 performs data transmission, using the communication section 21 and via the communication medium 40. The data to be transmitted is measurement data, setting information, communication information, request information, or the like, which are supplied from the health information communication device 10. Also, the health information collection device 20 performs data exchange using another communication section 25 and via the external communication medium 41, in order to exchange data with a healthcare service or other types of services.

In the health information collection device 20, the communication section 21 receives, from the health information communication device 10, measurement data including at least a measured value representing the health condition of a measurement target, via the communication medium 40. The data conversion section 24 recognizes a measurement name corresponding to the measured value in the supplied measurement data, and converts the measurement data based on a certain format. In case where the measurement data includes a code value corresponding to the measurement name, and communication information indicating how the measurement name and the code value relate to each other is supplied, the data conversion section 24 recognizes the measurement name by the communication information of the health information communication device 10 and the code value in the measurement data. In case where the measurement data includes data indicating the measurement name, the data conversion section 24 recognizes the measurement name by the data indicating the measurement name.

(Operation of Health Information Collection Device)

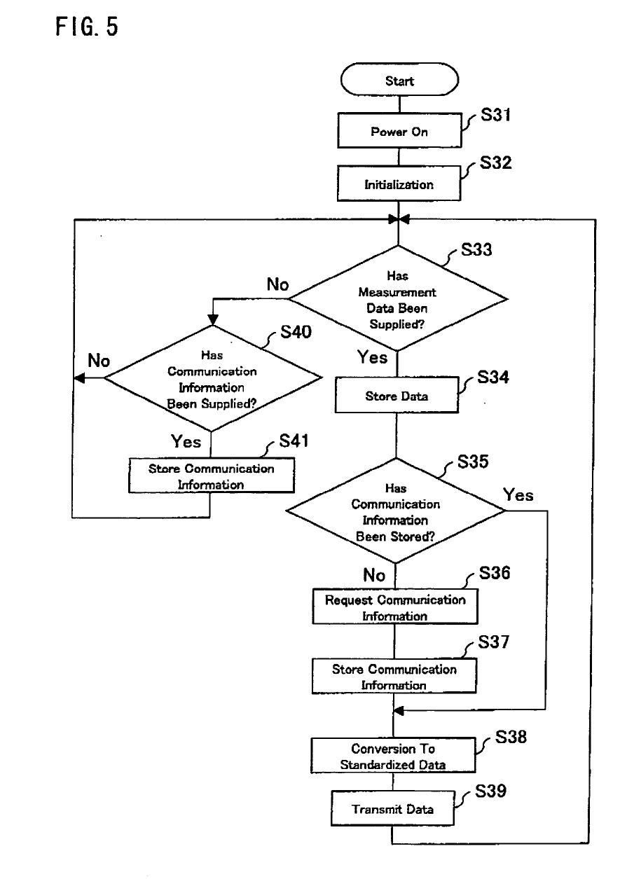

The following will describe in what manner the health information collection device 20 operates, in reference to the flowchart in FIG. 5.

The health information collection device is powered in S31, and initialized in S32. Thereafter, a main sequence loop for waiting measurement data supplied from the health information communication device 10 starts.

In the main sequence loop, whether or not measurement data has been supplied is determined in S33. If the data has been supplied, the process proceeds to S34. If the data has not been supplied, the process proceeds to S40.

The supplied data is stored in S34, and the process proceeds to S35. In S35, whether or not communication information has been stored is checked. If stored, the process proceeds to S38. If not stored, the process proceeds to S36. In S36, a request of communication information is carried out, i.e. request information is outputted. The process then proceeds to S37. In S37, the communication information is stored to be associated with the identifier of the device, e.g. a physical address for communication, and the process proceeds to S38. In S38, the measurement data is converted to standardized data, in accordance with a certain format. The process then proceeds to S39. In S39, the standardized data as a result of the conversion in S38 is supplied to a database of a healthcare service or a provider of a healthcare service. The process then goes back to S33.

In S40, whether or not communication information has been supplied is determined. If not supplied, the process goes back to S33. If supplied, the process proceeds to S41. In S41, the communication information is stored in the storage section 23, and the process goes back to S33.

As described above, communication information is supplied when the health information collection device 20 is powered. On this account, whether or not the communication information has been supplied is determined in the main sequence loop. The supplied communication information is stored in storage means, together with the identifier of the transmitting-end device. In case where, in the main sequence loop, measurement data is supplied from the health information communication device 10, it is determined whether or not the communication information of the health information communication device, which is the sender of the measurement data, is stored in the storage means. If such measurement data is not stored, a request of the communication information is supplied to the health information communication device which is the sender, so that the communication information of the sender is acquired. After acquiring both the communication information and the measurement data, the health information collection device generates standardized data by performing data conversion so as to generate data with XML or other formats, for transmitting data to a healthcare service or a database used for providing a service. The standardized data is supplied to a healthcare service or other types of services.

As described above, in the biological information collection system 30, the health information communication device 10 can transmit, to a transmitting end, communication information such as a measurement name, which corresponds to the performance of the health information communication device 10. It is therefore possible to provide necessary and sufficient information regarding data to be transmitted. Also, since communication information can be supplied to each health information communication device, it is possible to use a measurement item which is required by only one health information communication device. Also, an analysis can be carried out by setting a measurement item for a code value which is arbitrarily determined in each device. In case where a new measurement function is added, an additional allocation to a code value can be done by a firmware. Also, a measurement function which is no longer required because of, for example, upgrading of functions can be easily removed. This allows the health information communication device 10 to transmit latest information.

The biological information collection system 30 adopts a health information collection device 20 which can store and use communication information which has been supplied in advance. This makes it possible to construct a system where data analysis is possible in every situation. When the health information collection device 20 is altered or re-started, the health information collection device 20 does not have communication information of health information communication devices 10. The health information collection device 20 can require the health information communication devices 10 to transmit communication information as need arises, and receive the communication information. The biological information collection system 30 can therefore perform data collection, using latest communication information of the health information communication devices 10.

A mobile phone may have the functions of the health information communication device 10. In such a case, the mobile phone can transmit communication information and measurement data, in addition to original functions of the mobile phone. Also, such a mobile phone may be provided with a sensor that measures health information of a measurement target. In such a case, a value obtained by the sensor may be transmitted as the aforesaid measured value.

A mobile phone may also have the functions of the health information collection device 20. In such a case, the mobile phone can receive communication information and measurement data and convert the measurement data based on a particular format, in addition to original functions of the mobile phone. Furthermore, the mobile phone may transmit, to a server, the supplied measurement data which has been converted based on the format.

The following will describe an example of communication information generated by communication information generating means of the health information communication device 10. It is noted that the arrangement and content of communication information is not limited to the following example.

(Example 1 of Communication Information)

Communication information of the present example is constituted by a communication mode identifier and a communication information unit.

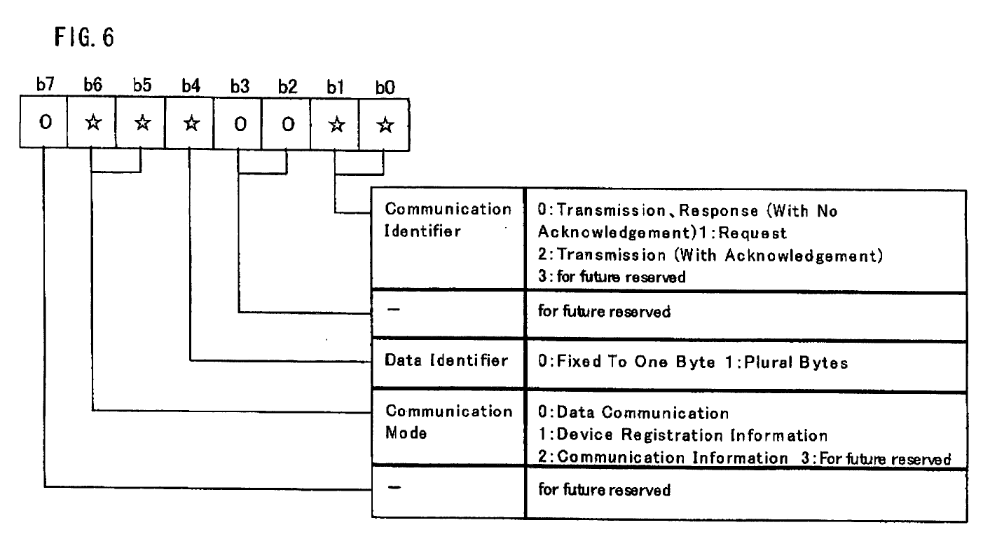

The communication mode identifier is used for determining whether data is measurement data or communication information. FIG. 6 shows an example of the communication mode identifier. A one-byte area in a header or data part of a data frame is used as an identifier, and a part of a bit field of the identifier is used as a field for determining whether data is measurement data or communication information. Alternatively, the following arrangement may be used: in the bit field of the identifier, a field for determining if communication information is sent or requested is secured, so that whether communication information is sent or requested is determined.

Since the data in the present example is communication information, the communication mode identifier is set to communication information. Subsequent to the identifier, a communication information unit including a binary value as a code value and a measurement name is provided. Plural communication information units may be serially provided here. The binary value and the measurement name are described as follows. In accordance with the data length of the binary value, the binary value and a data length identifier are described. In case where the binary value is one byte, the data length identifier is unnecessary because the data length is uniquely determined. That is, the binary value may be one byte or more than one byte. More than 256 types of measurement names are available in case where the binary value is more than one byte. The measurement name is described in such a manner that (i) addition of a data length identifier of the measurement name, (ii) a code identifier indicating the character code of the measurement name, and (iii) the data array of the measurement name are described.

The order of describing the identifiers is not particularly limited. However, the order of the identifiers in the binary value and the order of the identifiers in the measurement name are preferably identical with each other. When the code value is a binary value, the code value has a simple data format. It is therefore possible to restrain the data size.

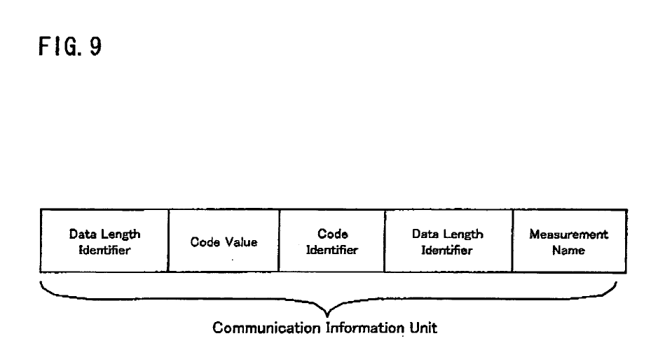

FIG. 9 shows an example of a data format of a communication information unit in communication information. As shown in the figure, according to the data format of the communication information unit, the following items are described in this order: a data length identifier which indicates the length of a code value (binary value); the code value (binary value); a code identifier which indicates the character code of a measurement name; a data length identifier of the measurement name; and the data string of the actual measurement name. Sets of data each of which corresponds to one code value (i.e. communication information unit) are grouped into one set of data. By generating such a set of data, sets of communication information for all measurement names can be supplied. Plural communication information units are generated, and supplied at one time. This makes it possible to reduce the traffic on the communication medium. The border between communication information units is identified by a data identifier which is added to the head or end of the data.

In case where a code value is one byte, the data length identifier of the code value is not used. This makes it possible to reduce an amount of transmitted data. It is possible to determine whether a code value is fixed to one byte or has more than one byte, by providing a field for the determination in a bit field of a communication mode identifier, as shown in FIG. 6.

In the present example, a code identifier which indicates a character code is used because the measurement name of the communication information unit is described as a character string. If the measurement name is not described as a character string, the code identifier is unnecessary. The code identifier can indicate which character code is used for describing the measurement name, when the measurement name is described as a character string.

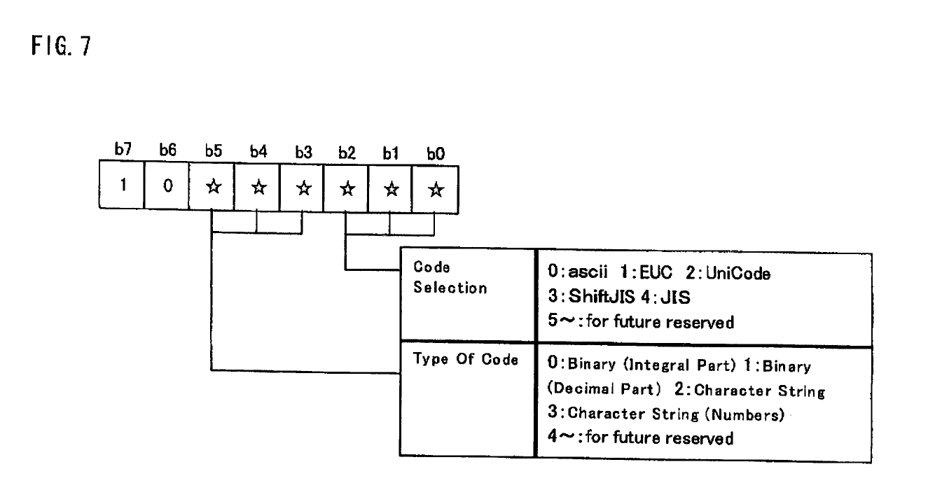

FIG. 7 shows an example of the code identifier. An identifier is provided in a one-byte area of a data section of a data frame. Using a part of a bit field of the identifier, a field for identifying a character code is secured. Also, a field for identifying the type of a code is provided in the bit field of the identifier. These two identification fields make it possible to identify which character code is used for describing a character string and whether a code is a number or a binary code.

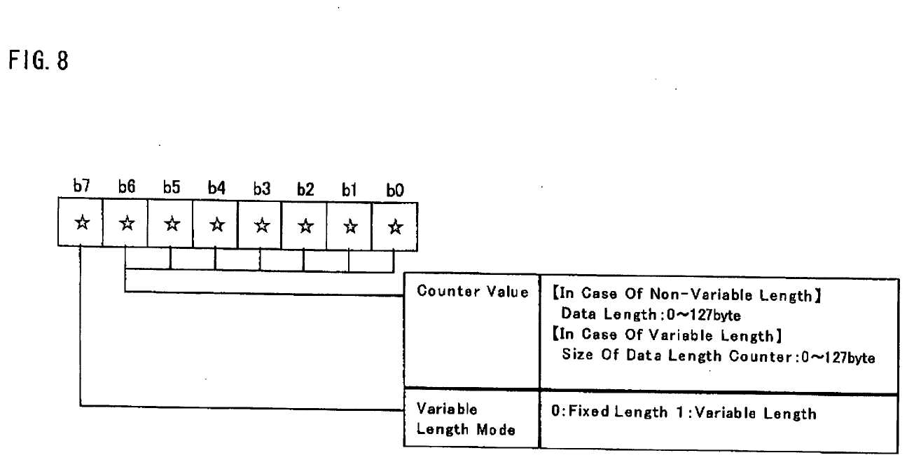

FIG. 8 shows a data length identifier which is used for identifying a data length. While a typical data length identifier indicates the data length by the value thereof, the data length identifier of the present example is used for switching between the following two cases: the data length is indicated by the most significant bit; and a data length counter is newly provided. When the most significant bit is 0, the length up to 127 bytes is represented by low 7 bits. When the most significant bit is 1, low 7 bits indicate the length of a newly-provided counter which indicates the data length. The actual data length is represented by the counter value.

(Example 2 of Communication Information)

Communication information of the present example is constituted by: a communication mode identifier; data of accompanied conditions regarding a measurement name; and a data identifier which indicates that a communication information unit is provided with the accompanies conditions.

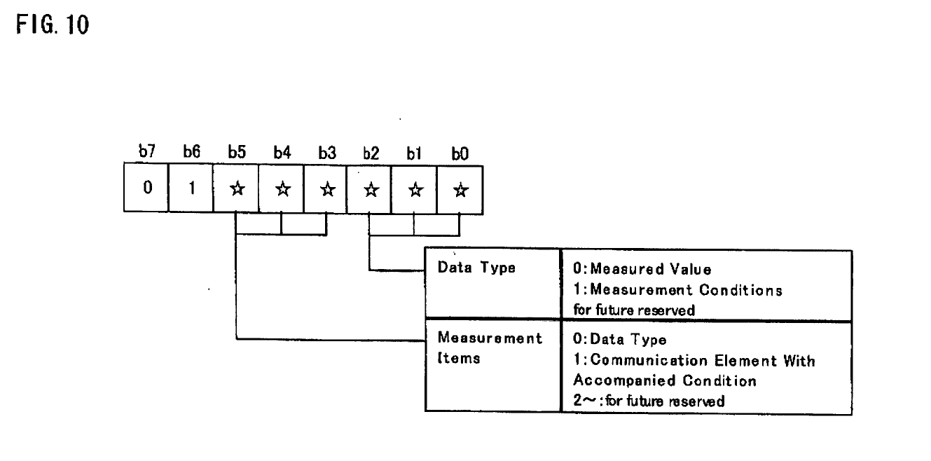

FIG. 10 shows an example of the data identifier which indicates that data is a communication information unit with accompanied conditions. An identifier is provided in one-byte area in a data section of a data frame. Using a part of a bit field of the identifier, a field for identifying whether data is a measurement name or accompanied conditions is secured. With this identification field, the type of the data is identified.

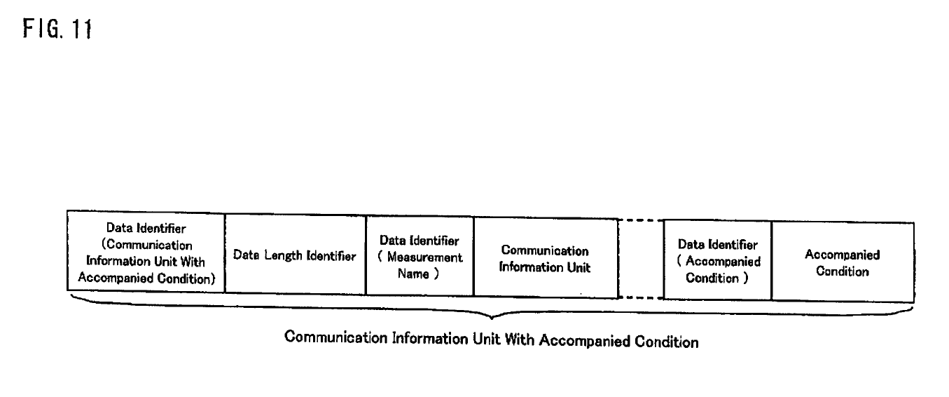

FIG. 11 shows an example of a data format of a communication information unit with accompanied conditions, in the communication information of the present example. According to this data format, a data identifier which indicates a measurement name is provided at the head of the data format shown in FIG. 9. With this, whether the data is a measurement name or accompanied conditions is identified. Subsequent to the data format shown in FIG. 9, the data of accompanied conditions regarding the measurement name is provided. The data format of the data of the accompanied conditions may be identical with the data format shown in FIG. 9. The data string of a measurement name in FIG. 9 (i.e. “measurement name” in FIG. 9) is the data string of actual accompanied conditions.

The items of accompanied conditions of a measurement name do not change irrespective of the type of measurement. The items of the accompanied conditions of a measurement names are, for example, a unit of a measured value and the number of measuring steps of a measured value. If such accompanied conditions with fixed items are supplied in advance, it is possible to use data when needed, by retaining the content of initial data, without supplying data each time measurement is carried out. This makes it possible to improve the efficiency of data transmission.

Each set of communication information with associated conditions, in which a measurement name and accompanied conditions are grouped, is identified using a data identifier and a data length identifier which indicate that the data is communication information with associated conditions. This makes it possible to transmit required communication information with associated conditions, by one information transmission. On this account, the efficiency of data transmission is improved and communication traffic is reduced.

The following will describe measurement data which is generated by measurement data generating means of the health information communication device 10. It is noted that the arrangement and content of communication information are not limited to the following example.

(Example 1 of Measurement Data)

Measurement data is constituted by a communication mode identifier and a measurement data unit (element, measurement element, and data group).

The communication mode identifier is used for identifying whether data is measurement data or communication data. In case of measurement data, an example of a communication mode identifier is shown in FIG. 6. The communication mode identifier is set so as to indicate that data is measurement data.

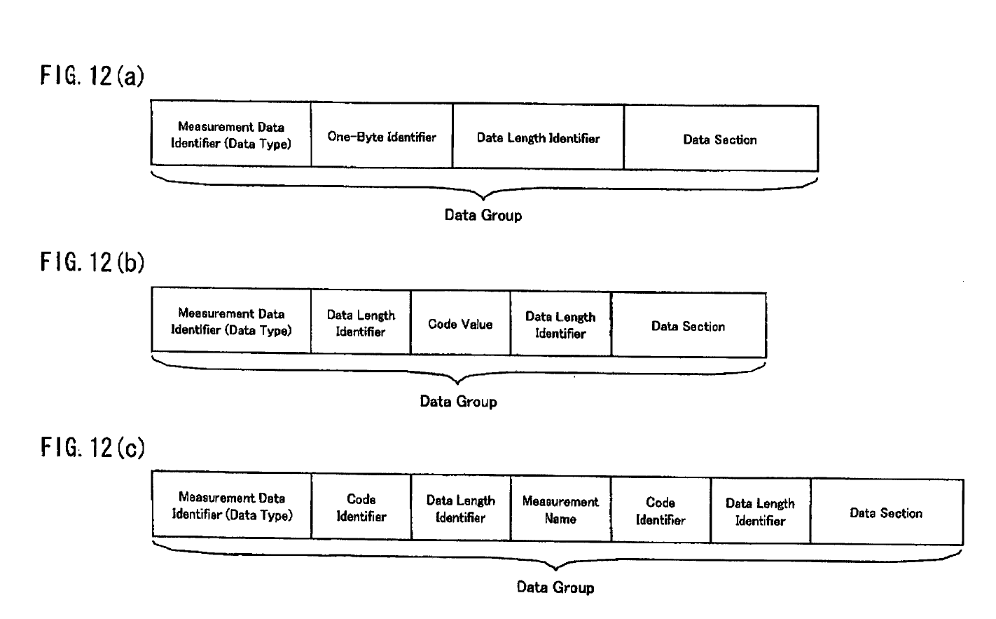

In the present example, a measurement data unit is arranged in such a manner that a code value, a measurement data identifier which indicates that the data is a measured value, and a data length identifier which indicates the length of a data string indicating the measured value, and the data string (corresponding to “data section” in the figure) are provided in series. The data format of the measurement data unit is a data group shown in FIG. 12(a). The data format shown in FIG. 12(a) uses a one-byte binary value for a measurement name, so as not to have a code identifier and a data length identifier. Such data groups may bc provided in series and transmitted as measurement data.

In case where a measurement name is made up of more than one byte, as shown in FIG. 12(b), not less than 255 types of code values can be used by replacing the one-byte code value in FIG. 12(a) with a data length identifier and a multiple-byte code value. Also, as shown in FIG. 12(c), not less than 255 types of actual measurement names can be used, by replacing the data length identifier and the multiple-byte code value in FIG. 12(b) with a code identifier which indicates a character code and a multiple-byte character string of a measurement name. In this case, a code identifier which indicates that the data in the data section is a measured value is added. In this manner, it is possible to use an actual measurement name as measurement data.

On this account, in case where the plural-byte format is used, it is possible to select either a code value or an actual measurement name, for measurement data to be transmitted. In case where a one-byte-fixed format in which a one-byte code value is adopted is used concurrently with the plural-byte format, a measurement name which is not frequently transmitted is described with more than one byte, whereas a measurement name which is frequently transmitted is described with one byte. This arrangement makes it possible to efficiently carry out data communication. In a system in which each of all measurement names is described with several bytes, actual measurement names are transmitted without any conversion. With this, it is unnecessary to perform conversion of measurement names in the health information collection device 20.

The measurement data unit may be additionally provided with (i) data of accompanied conditions regarding a measured value (i.e. conditions) and (ii) a measurement data identifier which indicates that the data is a measurement data unit with accompanied conditions (i.e. an element with conditions). Using measurement data with such a data format, it is possible to transmit data with accompanied conditions regarding a measured value. Non-limiting examples of the accompanied conditions regarding a measured value are environmental conditions at the time of measurement, properties of the measured value, precision of the measurement, state of the measurement target, and installation condition of the measuring device. To distinguish a measured value from accompanied conditions of the measured value, the measurement data unit includes an identifier shown in FIG. 10.

Receiving measurement data including the measurement data unit with the aforesaid associated conditions, the health information collection device 20 extracts an identifier from the supplied measurement data, using analyzing means (not illustrated) which can identify an identifier shown in FIG. 10, by which identifier whether data is a measured value or accompanied conditions (measurement conditions) of the measured value is identified. Then the health information collection device 20 stores the extracted identifier in the storage section 23 in such a manner that a measured value and accompanied conditions thereof are distinguishable. Thereafter, if standardized data is required, the health information collection device 20 reads out, from the storage section 23, communication information which has been acquired in advance and a measured value with accompanied conditions, which value corresponds to the code value of the communication information. The standardized data with a particular format is then generated using the data conversion section 24 which can perform conversion to either (i) XML data which can be used by a provider of a healthcare service or a database of the service or (ii) a data format corresponding to the specifications of the service. To the provider of the healthcare service or the a database of the service, the converted standardized data with the certain format is supplied, with the result that highly-reliable data and precision information of a measured value, which are required for improving the quality of the service, are provided.

(Example 2 of Measurement Data)

Measurement data of the present example is constituted by a communication mode identifier and plural measurement data units with accompanied conditions, which data units have been described above (Example 1 of measurement data). Measurement data units with accompanied conditions are grouped into one data group, and a data boundary between two data groups is indicated by an identifier. With this arrangement, plural measurement data units with accompanied conditions can be transmitted at one time.

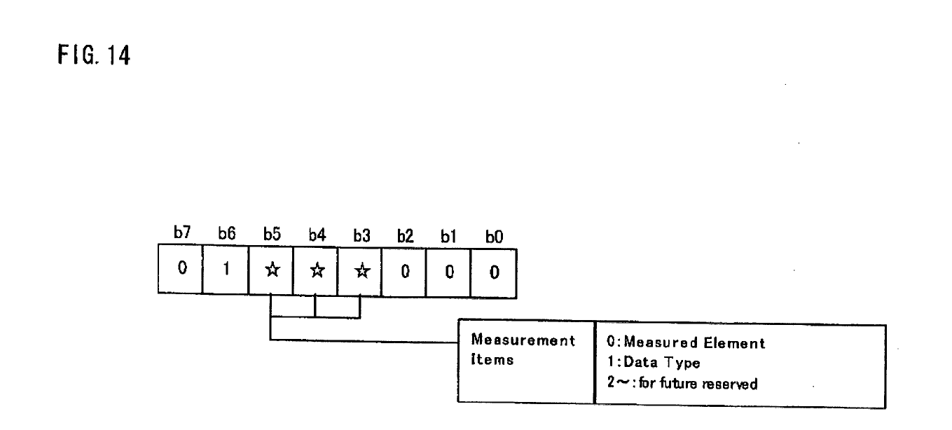

The identifier indicating the data boundary is generated by adding a bit field of a measurement data identifier shown in FIG. 10. An example of the identifier is shown in FIG. 14. This data format makes it possible to identify a data boundary between measurement data units with accompanied conditions. With this arrangement, plural measurement data units with accompanied conditions can be transmitted at one time. Since measurement data units may include measured values which are concurrently measured, sets of data can be transmitted at one time as, for example, measurement values for one measurement.

According to the data format of the present example, which supports measurement data units with accompanied conditions, a data group which is a measurement data unit with accompanied conditions is arranged as follows. That is, an identifier indicating a data boundary, a data length identifier indicating the data length of a measurement data unit with accompanied conditions, and a data group are provided in series and in this order. Data groups each of which is arranged as above are also provided in series.

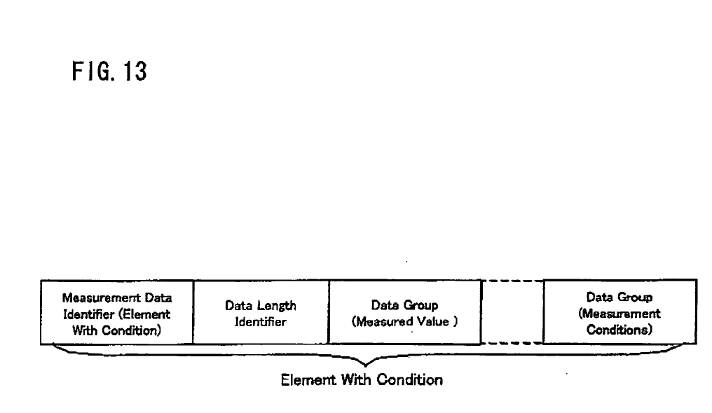

In the present example, an identifier indicating a data boundary between data groups is a measurement data identifier of the above (Example 1 of measurement data), which indicates that data is measurement data with accompanied conditions. On this account, the identifier in the present example has a data format shown in FIG. 13. This data format is arranged as follows: (i) a measurement data identifier which indicates that there are plural measurement data units with accompanied conditions and (ii) a data length identifier which indicates the data length of measurement data units with accompanied conditions are provided prior to data groups with the data format of any one of FIGS. 12(a)-12(c), which data groups are provided in series. In other words, the measurement data of the present example is arranged in such a manner that, a communication mode identifier which indicates that data is measurement data, a measurement data identifier which indicates that there are plural measurement data units with accompanied conditions, a data length identifier which indicates the data length of measurement data units with accompanied conditions, and plural data groups are provided in series.

Receiving measurement data including measurement data units with accompanied conditions, the health information collection device 20 extracts each of the measurement data units from the supplied measurement data, using analyzing means (not illustrated) which can identify an identifier as shown in FIG. 14. The health information collection device 20 then stores, in the storage section 23, each measured value and one or more accompanied condition thereof, in such a manner that a measured value and an accompanied condition thereof are distinguishable. When standardized data is required thereafter, the health information collection device 20 reads out, from the storage section 23, communication information which has been acquired in advance and a measured value with at least one accompanied condition, which value corresponds to the code value of the communication information. The standardized data with a particular format is then generated using the data conversion section 24 which can perform conversion to either (i) XML data which can be used by a provider of a healthcare service or a database of the service or (ii) a data format corresponding to the specifications of the service. In this manner, plural measurement data units are processed in one communication. This makes it possible to increase the efficiency of the service and reduce the communication traffic.

(Example 3 of Measurement Data)

Measurement data of the present example is constituted by a communication mode identifier and measurement group data generated by putting together more than one measurement data units having identical accompanied conditions by using the identical accompanied conditions as a key, among measurement data units having the accompanied conditions described above (in Example 1). The measurement group data includes (i) one identical accompanied condition and (ii) a measurement data identifier which indicates that more than one measurement data units having the identical accompanied condition are included.

Among the accompanied conditions of the measurement data units, accompanied conditions shared among all measurement data units are grouped. With this, it is possible to avoid the transmission of redundant data, and improve the efficiency of the data transfer. In doing so, an identifier for determining whether data is a measured value or an accompanied condition is provided.

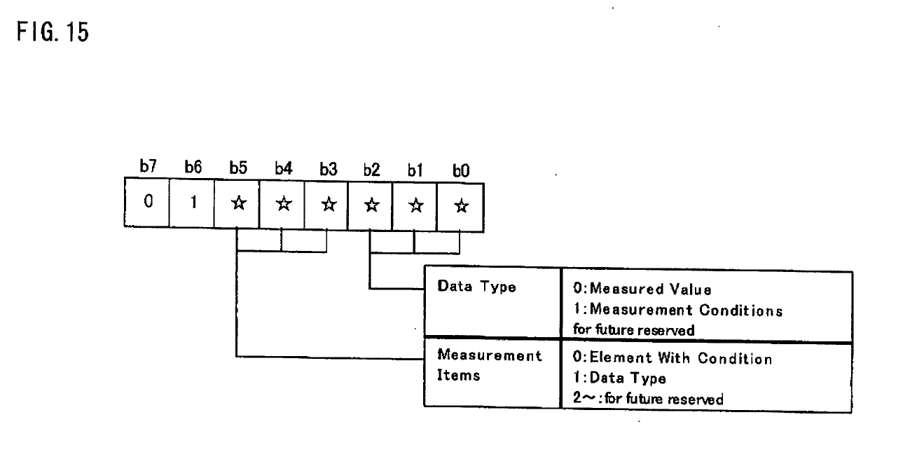

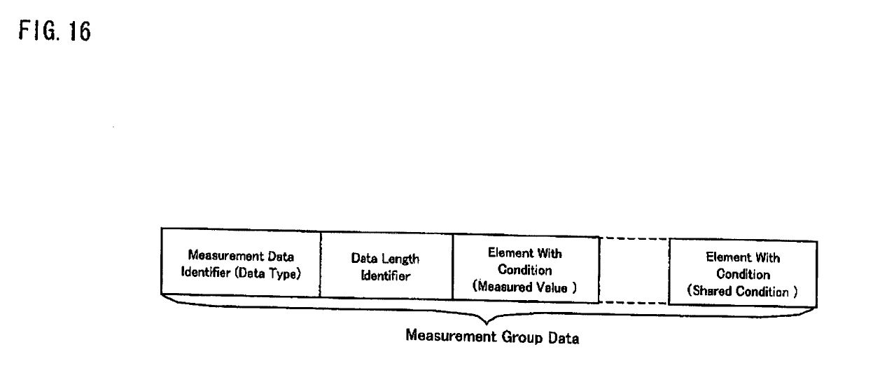

The measurement group data adopts a data format shown in FIG. 16. In this case, an identifier of a measurement data unit with accompanied conditions (i.e. element with conditions) is provided. This identifier uses both a bit field of a measurement item of the measurement data identifier and a bit field of a data type of the measurement data identifier. FIG. 15 shows an example of this identifier. The identifier is a measurement data identifier which indicates that data is measurement group data. Using this data format, it is possible to describe both an identifier of each measured value and an identifier shared between all measured values, such as measurement time. Moreover, since measurement data units can be hierarchically described, correlations between measurement data units and accompanied conditions are clarified. This makes it unnecessary to redundantly describe accompanied conditions. On this account, measured values including optimum measurement conditions can be transmitted, with the result that detailed measurement data is efficiently transmitted.

Receiving measurement data including the measurement group data of the present example, the health information collection device 20 determines whether or not the supplied data is a measurement data unit with accompanied conditions, using analyzing means (not illustrated) which identifies an identifier shown in FIG. 15. This determination is carried out because the measurement data supplied by data communication may include plural measurement data units. Also, since it is determined whether a measurement data unit with accompanied conditions is a shared accompanied condition or each measured value, the received measurement data is stored in the storage section 23. In the storage section 23, the supplied data is categorized into items of shared accompanied conditions and measured values. When standardized data is required, the health information collection device 20 reads out, from the storage section 23, communication information which has been acquired in advance and measurement data units with accompanied conditions, which correspond to the code value of the communication information. Standardized data with a certain format is generated using the data conversion section 24 which can perform conversion to hierarchical data supported in a provider of a healthcare service or a database of the service. Since shared conditions regarding the measurement have been extracted in advance, reliable data and precision information of a measured value, which are required for improving the quality of the service, are provided without performing data processing by searching standardized data on the health information collection device 20 side.

(Example 4 of Measurement Data)

Measurement data of the present example is constituted by a communication mode identifier and sets of measurement group data described above (Example 3).

The sets of measurement group data are put together in consideration of shared conditions. On this account, the sets of measurement group data can be set as a single set of measurement data. In case where plural sets of measurement group data are transmitted at one time, an identifier by which a data boundary between sets of measurement group data is indicated is required.

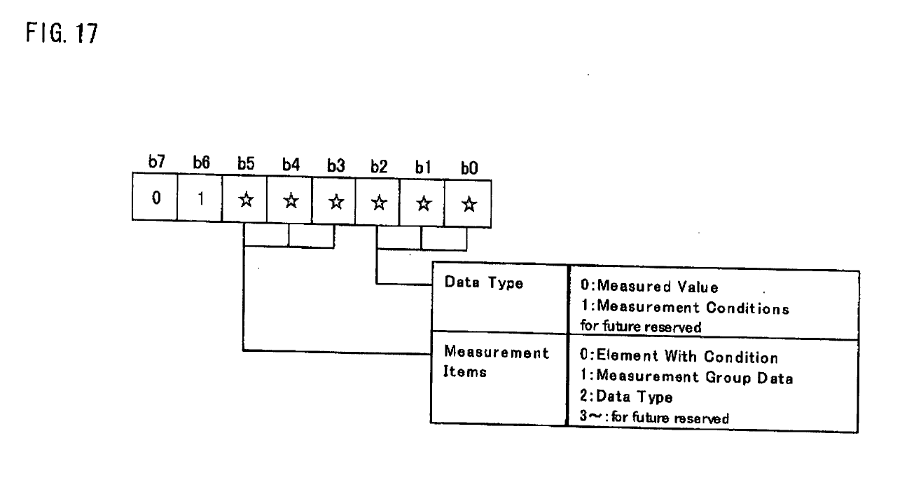

An identifier by which a data boundary between sets of measurement group data is indicated is generated by adding a bit field of the measurement data identifier shown in FIG. 15. An example of this identifier is shown in FIG. 17. This data format makes it possible to identify a data boundary between sets of measurement group data. On this account, plural sets of measurement group data can be transmitted at one time. In case where sets of measurement group data are acquired at the same time, sets of data can be transmitted at one time. Also, sets of data which are not required to be transmitted in real time can be transmitted altogether.

The data format of the present example, in which plural sets of measurement group data are included, is arranged as follows. That is, a measurement data identifier indicating that data is measurement group data, a data length identifier which indicates the data length of the measurement group data, and the measurement group data are provided in series and in this order, and plural data groups each of which is arranged in this manner are provided in series.

In the present example, an identifier which indicates a data boundary between data groups is a measurement data identifier which indicates that data is measurement group data described in Example 3. On this account, the data format of the present example is arranged in such a manner that, a measurement identifier which indicates that there are plural sets of measurement group data, a data length identifier which indicates the data length of plural sets of measurement group data, and sets of measurement group data described in series are provided in this order, in addition to a communication mode identifier which indicates that data is measurement data.

Receiving measurement data of the present example, which includes sets of measurement group data, the health information collection device 20 extracts each set of measurement group data from the supplied measurement data, using analyzing means (not illustrated) which can identify an identifier shown in FIG. 17. The health information collection device 20 extracts the sets of data because the measurement data supplied by means of data communication may include more than one set of measurement group data. When standardized data is required, the health information collection device 20 reads out, from the storage section 23, communication information which has been acquired in advance and measurement data units with accompanied conditions, which units correspond to the code value of the communication information. Then conversion to either (i) XML data which can be used by a provider of a healthcare service or a database of the service or (ii) a data format corresponding to the specifications of the service, is carried out. After collecting data by means which extracts plural sets of measurement data one by one or altogether, standardized data with a particular format corresponding to a required data size is generated using the data conversion section 24. In this manner, it is possible to process plural sets of measurement data in one communication and select only required data. This makes it possible to increase the efficiency of the service and reduce the communication traffic.

Note that, in the embodiments above, the sections and processing steps of the health information communication device 10 and the health information collection device 20 can be realized in the following way: computing means such as a CPU executes a program stored in storing means such as a ROM (Read Only Memory) and RAM, so as to control input means such as a keyboard, output means such as a display, and communication means such as an interface circuit. Therefore, the functions and processes of the health information communication device 10 and the health information collection device 20 of the embodiments above are realized, only by causing a computer including the above-mentioned means to read the program from a storage medium and execute the program. Furthermore, storing the program in a removable storage medium, it is possible to realize the aforesaid functions and processes by an arbitrary computer.

The storage medium may be a memory (not shown) for process steps on a microcomputer. For example, the program medium is something like a ROM. Alternatively, the program medium may be such that a program reader device (not shown) as an external storage device may be provided in which a storage medium is inserted for reading.

In addition, in any case, the stored program is preferably executable on access by a microprocessor. Further, it is preferred if the program is retrieved, and the retrieved program is downloaded to a program store area in a microcomputer to execute the program. The download program is stored in a main body device in advance.

In addition, the program medium may be a storage medium constructed separably from a main body. The medium may be tape based, such as a magnetic tape or cassette tape; disc based, such as a flexible disc or hard disk including a magnetic disc and CD/MO/MD/DVD; card based, such as an IC card (including a memory card); or a semiconductor memory, such as a mask ROM, EPROM (Erasable Programmable Read Only Memory), EEPROM (Electrically Erasable Programmable Read Only Memory), and a flash ROM. All these types of media hold the program in a fixed manner.

In contrast, if the system is arranged to connect to the Internet or other communication network, the medium is preferably a storage medium which holds the program in a flowing manner so that the program can be downloaded over the communication network.

Further, if the program is downloaded over a communication network in this manner, it is preferred if the download program is either stored in a main body device in advance or installed from another storage medium.

The present invention is not limited to the description of the embodiments above, but may be altered by a skilled person within the scope of the claims. An embodiment based on a proper combination of technical means disclosed in different embodiments is encompassed in the technical scope of the present invention.

The present invention can be used for information communications for transmitting measurement data. Also, since the present invention is versatile and efficient as data communication, the present invention can be used in a partial system which adopts a low-speed communication line, in an information communication system. In particular, the present invention can be used for a system in which a health information communication device transmits measurement data indicating a health condition of the user, an in-home health information collection device (in-home gateway) collects plural sets of measurement data, and a provider of the healthcare service carries out health supervision of the user.

As described above, a measurement data communication device of the present invention, which transmits, to an information acquisition device, a measured value indicating a health condition of a measurement target, includes: communication information transmitting means for transmitting, to the information acquisition device, communication information which is constituted by a measurement name corresponding to the measured value and a code value corresponding to the measurement name; and measurement data generating means for generating measurement data, based on the code value and the measured value.

Also, a measurement data communication device of the present invention, which transmits measurement data to an information acquisition device which recognizes an actual measurement name of a measured value by either a code value or a character string of the measurement name, includes: measurement data generating means for generating the measurement data based on a code value corresponding to the measurement name and the measured value; and communication information generating means for generating communication information which indicates in what manner the code value and the measurement name correspond to one another, the communication information being transmitted to the information acquisition device prior to the transmission of the measurement data.

A method of controlling a measurement data communication device of the present invention, which transmits, to an information acquisition device, a measured value indicating a health condition of a measurement target, includes the steps of: transmitting, to the information acquisition device, a measurement name corresponding to the measured value and a code value corresponding to the measurement name, as communication information; and generating measurement data from the code value and the measured value.

A method of controlling a measurement data communication device of the present invention, which transmits measurement data to an information acquisition device which recognizes an actual measurement name of a measured value by either a code value or a character string of the measurement name, includes the steps of: generating the measurement data based on a code value corresponding to the measurement name and the measured value; generating communication information which indicates in what manner the code value and the measurement name correspond to one another; and transmitting the communication information to the information acquisition device, prior to the transmission of the measurement data.

The above-described measurement data communication device of the present invention may be arranged such that the code value is constituted by a single byte.

According to this arrangement, the code value has a simple data format. The data size is therefore restrained.

The above-described measurement data communication device of the present invention may be arranged such that the code value is made up of more than one byte.

According to this arrangement, the communication information and the measurement data can be generated even if the number of types of code values is more than 255 (256 types can be represented by one byte), i.e. in case where the number of the measurement names is not less than 256. On this account, 256 or more measurement names are available, and data communication is feasible without problems.

The above-described measurement data communication device of the present invention may be arranged such that in case where the communication information transmitting means does not transmit the communication information, the measurement data generating means generates the measurement data, based on the measured value and data indicating the measurement name.

According to this arrangement, an actual measurement name can be used in the measurement data. On this account, in case where the plural-byte format is used, it is possible to select either a code value or an actual measurement name, for measurement data to be transmitted. In case where a one-byte-fixed format in which a one-byte code value is adopted is used concurrently with the plural-byte format, a measurement name which is not frequently transmitted is described with more than one byte, whereas a measurement name which is frequently transmitted is described with one byte. This arrangement makes it possible to efficiently carry out data communication. In a system in which each of all measurement names is described with several bytes, actual measurement names are transmitted without any conversion. With this, it is unnecessary to perform conversion of measurement names in the information acquisition device.

The above-described measurement data communication device of the present invention may be arranged such that the communication information transmitting means transmits, as the communication information, (i) at least one communication information unit including data indicating the measurement name and a data length identifier which indicates the length of the data indicating the measurement name, and (ii) a communication mode identifier which indicates that the communication information is transmitted.

According to this arrangement, a code value surely corresponds to a measurement name in communication information. Also, it is possible to indicate that data is communication information.

The above-described measurement data communication device of the present invention may be arranged such that in case where the data indicating the measurement name is represented by a character string, the communication information transmitting means adds, to said at least one communication information unit, a code identifier corresponding to the character string.

According to this arrangement, it is possible to indicate which character code is used to describe a measurement name, in case where the measurement name is constituted by a character string.

The above-described measurement data communication device of the present invention may be arranged such that the communication information includes plural communication information units in each of which a data identifier indicating that a measurement name is included is provided at a head or an end of a data frame.

According to this arrangement, it is possible to transmit plural communication information units at one time. The traffic in the communication medium is therefore reduced. The boundary between communication information units is indicated y a data identifier which indicates that a measurement name is transmitted.

The above-described measurement data communication device of the present invention may be arranged such that the communication information transmitting means adds, to said at least one communication information unit, (i) data of at least one accompanied condition regarding the measurement name and (ii) a data identifier which indicates that said at least one communication information unit is provided with said at least one accompanied condition.

According to this arrangement, an accompanied condition regarding a measurement name is transmitted as communication information, so that detailed information regarding the measurement name is transmitted. Since an accompanied information regarding a measurement name does not change during the transmission, it is unnecessary to transmit the accompanied information twice or more. On this account, an accompanied condition is notified without increasing a data size of transmitted measurement data. Non-limiting examples of measurement names include a measurement unit and an increment thereof.

Also, a data identifier which indicates that measurement information unit with an accompanied condition is transmitted is provided at the head or end of the data frame of the communication information unit, and communication information including plural communication information units arranged as above is generated. With this, it is possible to transmit plural communication information units with accompanied conditions at one time. The boundary between communication information units with accompanied conditions is indicated by a data identifier which indicates that a communication information unit with an accompanied condition is transmitted.

The above-described measurement data communication device of the present invention may be arranged such that the measurement data includes: (i) at least one measurement data unit including the code value, data indicating the measured value, a data length identifier indicating the length of the data of the measured value, and a measurement data identifier indicating that the measured value is transmitted, and (ii) a communication mode identifier indicating that the measurement data is transmitted.

According to this arrangement, it is possible to generate measurement data in which a measured value is surely accompanied by a code value. Moreover, it is possible to indicate that data is measurement data.

The above-described measurement data communication device of the present invention may be arranged such that the measurement data generating means adds, to said at least one measurement data unit, (i) data of at least one accompanied condition regarding the measured value and (ii) a measurement data identifier which indicates that said at least one measurement data unit is provided with said at least one accompanied condition.

According to this arrangement, an accompanied condition regarding a measured value is transmitted as communication information, so that detailed information regarding the measured value is transmitted. Non-limiting examples of accompanied conditions regarding a measured value are environmental conditions at the time of measurement, attributes, measurement precision, state of a measurement target, and an installation condition of a measuring device.

The above-described measurement data communication device of the present invention may be arranged such that the measurement data is made up of the plural measurement data units with the accompanied conditions.

According to this arrangement plural measurement data units with accompanied conditions are transmitted at one time. The traffic in the communication medium is therefore reduced. Moreover, a measurement data identifier which indicates that measurement data with an accompanied condition is transmitted is provided at either the head or the end of the data frame of the measurement data unit. With this, a measurement data unit is differentiated from another measurement data unit.

The above-described measurement data communication device of the present invention may be arranged such that the measurement data generating means puts together more than one of the plural measurement data units having identical accompanied conditions, by using the identical accompanied conditions as a key, so as to generate the measurement data which is measurement group data including said more than one of the plural measurement data units that have been put together, and the measurement group data includes (i) one identical accompanied condition and (ii) a measurement data identifier which indicates that said more than one of the plural measurement data units having the identical accompanied condition are included.

According to this arrangement, an accompanied conditions shared between measured values is included only once in measurement data. This makes it possible to reduce the data size because an accompanied condition is not redundantly transmitted.

Furthermore, since a group of plural measured values which are put together by using a shared accompanied condition as a key, for example, measured values obtained at different times are transmitted altogether, in case where the measured values are not necessarily transmitted in real-time. According to this arrangement, the communication medium is efficiently used by transmitting the aforesaid data group when measurement data which requires real-time transmission is not transmitted.

The measurement group data in which plural measurement data units having an identical accompanied condition are put together is made up of the identical condition and measured values. Each of the measured values is provided with an accompanied condition. On this account, a receiver of the measurement group data can carry out data analysis of each measured value.

The above-described measurement data communication device of the present invention may be arranged such that the measurement data includes plural sets of the measurement group data.

According to this arrangement, plural sets of group data are transmitted at one time. The traffic in the communication medium is therefore reduced. A measurement data identifier which indicates a group of measurement data units which are put together by using the shared accompanied condition as the key is added to the head or end of the data frame of the measurement group data. This makes it possible to distinguish a set of measurement group data from another set of measurement group data.

A health information communication device of the present invention includes the measurement data communication device as described above and a sensor by which health information of a measurement target is obtained, and the value obtained by the sensor is used as the aforesaid measured value.

According to the arrangement above, correspondence between a measurement name of health information obtained by the sensor and a code value is notified in advance. On this account, it is possible to notify an actual measurement name of health information, which corresponds to a code value which is transmitted later. Therefore, under any circumstances, it is possible to cause a receiving end to recognize a measurement name of health information corresponding to a code value, by transmitting measurement data.

Moreover, a measurement name of health information obtained by the sensor is transmitted in advance. This makes it possible to perform transmission of measurement data, without increasing the data size thereof.

An information acquisition device of the present invention includes: first communication means for receiving, via a network, measurement data which includes at least a measured value indicating a health condition of a measurement target; and measurement data converting means for recognizing a measurement name corresponding to the measured value in the supplied measurement data and converting the measurement data based on a particular format, in case where the measurement data includes a code value corresponding to the measurement name and there has been supplied communication information which indicates a relationship between the measurement name and the code value, the measurement data converting means recognizing the measurement name by the communication information and the code value in the measurement data, whereas in case where the measurement data includes data indicating the measurement name, the measurement data converting means recognizing the measurement name by the data indicating the measurement name.

The information acquisition device of the present invention receives, via a network, communication information and measurement data from the measurement data communication device as described above, recognizes the measurement name of the measured value in reference to a code value or an actual character string of the measurement name, which is included in the supplied measurement data, and converts the measurement data based on a particular format.

As described above, a method of controlling an information acquisition device of the present invention includes the steps of: (i) receiving, via a network, measurement data including at least a measured value which indicates a health condition of a measurement target; and (ii) recognizing a measurement name corresponding to the measured value which is included in the supplied measurement data, and converting the measurement data based on a particular format, in the step (ii), in case where the measurement data includes a code value corresponding to the measurement name and there has been supplied communication information which indicates a relationship between the measurement name and the code value, the measurement name being recognized by the communication information and the code value in the measurement data, whereas in case where the measurement data includes data indicating the measurement name, the measurement name being recognized by the data indicating the measurement name.

The method of controlling the information acquisition device of the present invention includes the steps of: receiving, via a network, communication information from the measurement data communication device as described above; receiving measurement data after receiving the communication information; and recognizing a measurement name of a measured value in reference to a code value or an actual character string of the measurement name, which is included in the supplied measurement data, and converting the measurement data based on a particular format.

The above-described information acquisition device of the present invention may further include second communication means for transmitting, to a server, the measurement data converted by the data converting means, via a high-speed communication medium.

The above-described information acquisition device of the present invention may be arranged such that the first communication means transmits, to a device which has transmitted the measurement data, request information to request that device to return the communication information regarding the measurement data.

The above-described information acquisition device of the present invention may further include request information transmitting means. In case where a code value of supplied measurement data cannot be recognized, the request information transmitting means transmits request information to the measurement data communication device which has transmitted the measurement data, to request the measurement data communication device to return the communication information corresponding to the measurement data.

According to this arrangement, communication information is supplied when a code value in measurement data is unrecognizable. Therefore, a measurement name of a measured value is always recognizable by a code value. On this account, measurement data with the same measurement name is always converted based on the same format.

To solve the above-identified problem, the health information collection device of the present invention receives, via a network, the communication information and the measurement data from the aforesaid health information communication device, recognizes the measurement name of the measured value, in reference to a code value or an actual character string of the measurement name, which is included in the supplied measurement data, and converts the measurement data based on a particular format.

According to the arrangement above, the correspondence between a code value and a measurement name of health information obtained by the sensor is notified prior to the supply of measurement data from a health information communication device. On this account, even when measurement data in which the same measurement name has a different code value is supplied, the sets of measurement data are converted using the same format. The data is therefore standardized under any circumstances. On this account, for example, measurement data can be analyzed under any circumstances.

As described above, a measurement data communication system of the present invention includes: communication information transmitting means for transmitting, as communication information, (i) a measurement name corresponding to a measured value indicating a health condition of a measurement target and (ii) a code value corresponding to the measurement name; measurement data generating means for generating measurement data from the code value and the measured value; receiving means for receiving the communication information and the measurement data; and measurement data converting means for recognizing the measurement name based on the communication information and the code value included in the measurement data, and converting the measurement data based on a particular format.

In case where the communication information transmitting means does not transmit the communication information, the measurement data generating means generates the measurement data from the measured value and data indicating the measurement name, and the measurement data converting means recognizes the measurement name corresponding to the measured value, based on the data indicating the measurement name, which data is included in the supplied measurement data.

A measurement data communication system of the present invention includes: a measurement data communication device which generates measurement data from a measured value and a code value corresponding to a measurement name of the measured value, generate communication information which indicates how the code value and the measurement name corresponds to one another, and transmits the communication information prior to the transmission of the measurement data; and an information acquisition device which receives, via a network, the communication information and the measurement data from the measurement data communication device, recognizes the measurement name of the measured value, in reference to the code value or an actual character string of the measurement name, and converts the measurement data based on a particular format.

According to the arrangement above, a communication system is arranged such that the information acquisition device can recognize, in reference to a code value, a measurement name of a measured value in measurement data supplied from the measurement data communication device. On this account, even when measurement data includes a new measurement name with an arbitrary code value, sets of measurement data including the same measurement name are converted by the information acquisition device, based on the same format.

The aforesaid measurement data communication system of the present invention may further include a plurality of measurement data communication devices each of which includes the communication information transmitting means and the measurement data generating means.

The aforesaid measurement data communication system of the present invention may include a plurality of the aforesaid measurement data communication devices.

According to this arrangement, the information acquisition device can receive the communication information and the measurement data from a plurality of measurement data communication devices. Sets of measurement data including the same measurement name are stored with the same format. The information acquisition device can manage all sets of measurement data in this manner.

The measurement data communication device may be realized by a computer. In such a case, the present invention encompasses (i) a program for controlling the measurement data communication device, which causes a computer to operate as the aforesaid means so that the measurement data communication device is realized by the computer, and (ii) a computer-readable storage medium storing the program.

According to this arrangement, the effects of the measurement data communication device are obtained by causing a computer to read out and execute the program for controlling the measurement data communication device.

The measurement information acquisition device may be realized by a computer. In such a case, the present invention encompasses (i) a program for controlling the measurement information acquisition device, which causes a computer to operate as the aforesaid means so that the measurement information acquisition device is realized by the computer, and (ii) a computer-readable storage medium storing the program.

According to this arrangement, the effects of the measurement information acquisition device are obtained by causing a computer to read out and execute the program for controlling the measurement information acquisition device.

What is claimed is:

1. A measurement data communication device which transmits, to an information acquisition device, a measured value indicating a health condition of a measurement target,
the measurement data communication device comprising:
communication information transmitting means for transmitting, to the information acquisition device, communication information which is constituted by a measurement name corresponding to the measured value and a code value corresponding to the measurement name; and
measurement data generating means for generating measurement data, based on the code value and the measured value.

2. The measurement data communication device as defined in claim 1,
wherein, the code value is constituted by a single byte.

3. The measurement data communication device as defined in claim 1,
wherein, the code value is made up of more than one byte.

4. The measurement data communication device as defined in claim 1,
wherein, in case where the communication information transmitting means does not transmit the communication information, the measurement data generating means generates the measurement data, based on the measured value and data indicating the measurement name.

5. The measurement data communication device as defined in claim 1,
wherein, the communication information transmitting means transmits, as the communication information, (i) at least one communication information unit including data indicating the measurement name and a data length identifier which indicates the length of the data indicating the measurement name, and (ii) a communication mode identifier which indicates that the communication information is transmitted.

6. The measurement data communication device as defined in claim 5,
wherein, in case where the data indicating the measurement name is represented by a character string, the communication information transmitting means adds, to said at least one communication information unit, a code identifier corresponding to the character string.

7. The measurement data communication device as defined in claim 5,
wherein, the communication information includes plural communication information units in each of which a data identifier indicating that a measurement name is included is provided at a head or an end of a data frame.

8. The measurement data communication device as defined in claim 5,
wherein, the communication information transmitting means adds, to said at least one communication information unit, (i) data of at least one accompanied condition regarding the measurement name and (ii) a data identifier which indicates that said at least one communication information unit is provided with said at least one accompanied condition.

9. The measurement data communication device as defined in claim 1,
wherein, the measurement data includes:
(i) at least one measurement data unit including the code value, data indicating the measured value, a data length identifier indicating the length of the data of the measured value, and a measurement data identifier indicating that the measured value is transmitted, and (ii) a communication mode identifier indicating that the measurement data is transmitted.

10. The measurement data communication device as defined in claim 9,
wherein, the measurement data generating means adds, to said at least one measurement data unit, (i) data of at least one accompanied condition regarding the measured value and (ii) a measurement data identifier which indicates that said at least one measurement data unit is provided with said at least one accompanied condition.

11. The measurement data communication device as defined in claim 10,
wherein, the data of said at least one accompanied condition regarding the measured value includes at least one of: an environmental condition when the measured value is acquired; a property of the measured value; measurement precision; a state of a measurement target;
and an installation condition of a measuring device by which the measured value is acquired.

12. The measurement data communication device as defined in claim 10,
wherein, the measurement data is made up of the plural measurement data units with the accompanied conditions.

13. The measurement data communication device as defined in claim 12,
wherein, the measurement data generating means puts together more than one of the plural measurement data units having identical accompanied conditions, by using the identical accompanied conditions as a key, so as to generate the measurement data which is measurement group data including said more than one of the plural measurement data units that have been put together, and
the measurement group data includes (i) one identical accompanied condition and (ii) a measurement data identifier which indicates that said more than one of the plural measurement data units having the identical accompanied condition are included.

14. The measurement data communication device as defined in claim 13, wherein, the measurement data includes plural sets of the measurement group data.

15. A health information communication device, comprising:
the measurement data communication device defined in claim 1: and
a sensor which measures health information of a measurement target,
a value acquired by the sensor being used as the measured value.

16. An information acquisition device, comprising:
first communication means for receiving, via a network, measurement data which includes at least a measured value indicating a health condition of a measurement target; and
measurement data converting means for recognizing a measurement name corresponding to the measured value in the supplied measurement data and converting the measurement data based on a particular format,
in case where the measurement data includes a code value corresponding to the measurement name and there has been supplied communication information which indicates a relationship between the measurement name and the code value, the measurement data converting means recognizing the measurement name by the communication information and the code value in the measurement data, whereas
in case where the measurement data includes data indicating the measurement name, the measurement data converting means recognizing the measurement name by the data indicating the measurement name.

17. The information acquisition device as defined in claim 16, further comprising second communication means for transmitting, to a server, the measurement data converted by the data converting means, via a high-speed communication medium.

18. The information acquisition device as defined in claim 16,
wherein, the first communication means transmits, to a device which has transmitted the measurement data, request information to request that device to return the communication information regarding the measurement data.

19. A method of controlling a measurement data communication device which transmits, to an information acquisition device, a measured value indicating a health condition of a measurement target,
the method comprising the steps of:
transmitting, to the information acquisition device, a measurement name corresponding to the measured value and a code value corresponding to the measurement name, as communication information; and
generating measurement data from the code value and the measured value.

20. A method of controlling an information acquisition device, comprising the steps of:
(i) receiving, via a network, measurement data including at least a measured value which indicates a health condition of a measurement target; and
(ii) recognizing a measurement name corresponding to the measured value which is included in the supplied measurement data, and converting the measurement data based on a particular format,
in the step (ii),
in case where the measurement data includes a code value corresponding to the measurement name and there has been supplied communication information which indicates a relationship between the measurement name and the code value, the measurement name being recognized by the communication information and the code value in the measurement data, whereas
in case where the measurement data includes data indicating the measurement name, the measurement name being recognized by the data indicating the measurement name.

21. A measurement data communication system, comprising:
communication information transmitting means for transmitting, as communication information, (i) a measurement name corresponding to a measured value indicating a health condition of a measurement target and (ii) a code value corresponding to the measurement name;
measurement data generating means for generating measurement data from the code value and the measured value;
receiving means for receiving the communication information and the measurement data; and
measurement data converting means for recognizing the measurement name based on the communication information and the code value included in the measurement data, and converting the measurement data based on a particular format.

22. A measurement data communication system as defined in claim 21,
wherein, in case where the communication information transmitting means does not transmit the communication information, the measurement data generating means generates the measurement data from the measured value and data indicating the measurement name, and the measurement data converting means recognizes the measurement name corresponding to the measured value, based on the data indicating the measurement name, which data is included in the supplied measurement data.

23. The measurement data communication system as defined in claim 21 further comprising a plurality of measurement data communication devices each of which includes the communication information transmitting means and the measurement data generating means.

24. A program for controlling a measurement data communication device, the program causing a computer to function as the means of the measurement data communication device defined in claim 1.

25. A computer-readable storage medium, storing the program defined in claim 24.

26. A program for controlling an information acquisition device, causing a computer to function as the means of the information acquisition device defined in claim 16.

27. A computer-readable storage medium, storing the program defined in claim 26.

28. A mobile phone, functioning as the measurement data communication device defined in claim 1.

29. A mobile phone, comprising:
the measurement data communication device defined in claim 1: and
a sensor which measures health information of a measurement target,
a value acquired by the sensor being used as the measured value.

30. A mobile phone, functioning as the information acquisition device defined in claim 16.
